(19) United States
(12) Patent Application Publication
(10) Pub. No.: US 2016/0109636 A1
(43) Pub. Date: Apr. 21, 2016

(54) BACKLIGHT MODULE CAPABLE OF AVOIDING LIGHT LEAKAGE

(71) Applicant: Chicony Electronics Co., Ltd., New Taipei City (TW)

(72) Inventor: Hsin-Chin WENG, New Taipei City (TW)

(21) Appl. No.: 14/515,531

(22) Filed: Oct. 16, 2014

(51) Int. Cl. F21V 8/00; H01H 13/02

(52) U.S. Cl. CPC G02B 6/0031; H01H 13/023; H01H 2219/044; H01H 2219/062; H01H 2219/06

(57) ABSTRACT

In a backlight module, a shading film connected to the substrate has a first surface, a second surface and a first hole disposed thereon. The light guide plate is connected to the shading film while a second hole with a greater aperture than that of the first hole is disposed thereon. The shading film has an extra extending section compared to the light guide plate and a shading portion is disposed thereon. A third hole with a greater aperture than that of the second hole is disposed on the reflective sheet. A side of the reflective sheet near the third hole has an extra adhesive section while a side of the light guide plate near the second hole does not. The adhesive section connected to the extending section covers a side of the light guide plate near the second hole for preventing light from exiting through the second hole.

### TECHNICAL FIELD

The disclosure relates to a backlight module, more particularly to a backlight module used for a keyboard.

### BACKGROUND

Nowadays computers are widely used by people and are indispensable tools to them. Via the input device of a computer and the internet, electronic information can be transferred quickly. Keyboard is one of the common input devices. Nonetheless, when users are using the keyboard in a dim place, insufficient light make them unable to identify the marks, such as characters or symbols, on the keys, which is inconvenient for the users. For addressing these issues, related industries have introduced many luminous keyboards available for users.

The current luminous keyboards can perform a function of emitting light because of a backlight module. The backlight module comprises a light guide plate and a light-emitting element disposed on one side of the light guide plate. Light generated by the light-emitting element is guided by the light guide plate and then radiates.

The backlight module, however, requires one or multiple holes for positioning sticks or other components to be disposed on. This makes light generated by the light-emitting element leak through the hole(s), which results in the problem of light leakage. The problem of light leakage negatively effects users' experience of using keyboards because it is inconvenient and bothersome.

The disclosure intends to introduce a well-designed structure for solving the problems mentioned above.

### SUMMARY

The disclosure intends to introduce a backlight module capable of avoiding light leakage, for avoiding light leakage through holes which has a negative impact on comfort of using the keyboard. The disclosure provides a backlight module capable of avoiding light leakage, comprising a substrate, a shading film, a light guide plate, a light-emitting element and a reflective sheet. The shading film has a first surface and a second surface opposite to each other. The shading film forms a first hole penetrating the first surface and the second surface, and the shading film is connected with the substrate by the first surface. The light guide plate is connected to the second surface and forms a second hole corresponding to the first hole while the aperture of the second hole is greater than that of the first hole. A side of the shading film near the first hole has an extending section while a side of the shading film near the second hole does not, and a first shading portion is disposed on the extending section of the shading film. The light-emitting element is disposed on a light entering side of the light guide plate. The reflective sheet is connected to a side of the light guide plate and forms a third hole corresponding to the second hole while the aperture of the third hole is greater than that of the second hole. A side of the reflective sheet near the third hole has an adhesive section while a side of the light guide plate near the second hole does not. The adhesive section is connected with the extending section and covers a side of the light guide plate near the second hole, for preventing light generated from the light-emitting element from exiting from the second hole.

Compared to prior art, the position of the light guide plate at the holes shrinks by a distance relative to the shading film. Thus, the shading film has an extending section while the light guide plate does not. On the other hand, the reflective sheet has an adhesive section while the light guide plate does not. The glue is disposed between the extending section and the adhesive section and covers one side of the light guide plate. Consequently, the light generated by the light-emitting element does not leak at the shrunk side of the light guide plate when being transferred through the light guide plate, thereby avoiding light leakage. As a result, users may use the keyboard comfortably.

### BRIEF DESCRIPTION OF THE DRAWINGS

The present disclosure will become more fully understood from the detailed description and the drawings given herein below for illustration only and thus does not limit the disclosure, wherein:

FIG. 1 is a sectional view of the assembly of a backlight module capable of avoiding light leakage according to one embodiment of the disclosure;

FIG. 2 is a partially enlarged view of the section A of FIG. 1;

FIG. 3 is a schematic view of a backlight module capable of avoiding light leakage according to another embodiment of the disclosure;

FIG. 4 is a schematic view of a backlight module capable of avoiding light leakage according to still another embodiment of the disclosure;

FIG. 5 is a schematic view of a backlight module capable of avoiding light leakage according to the other embodiment of the disclosure; and

FIG. 6 is a schematic view of the positions of the holes of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

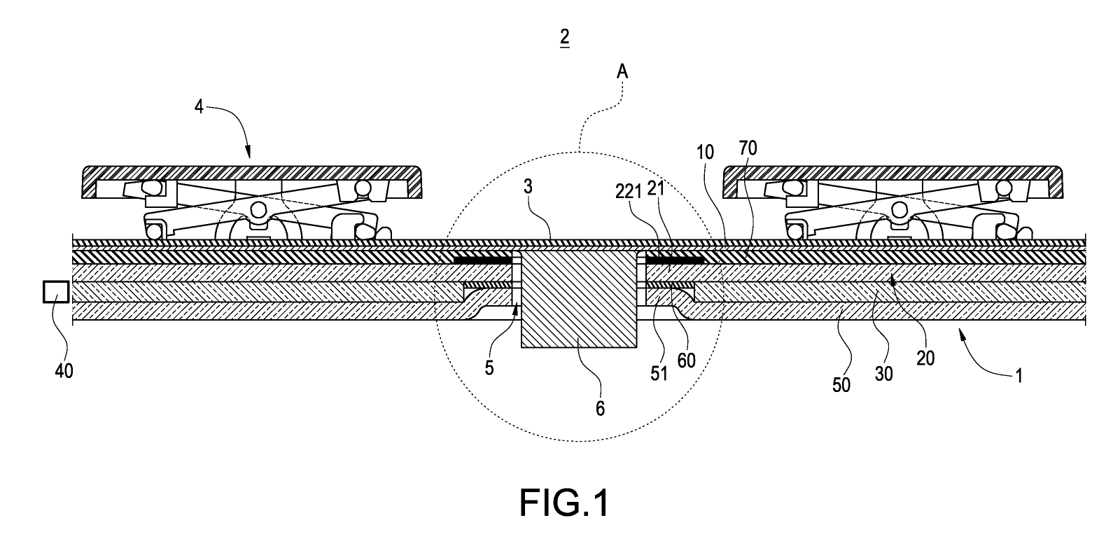

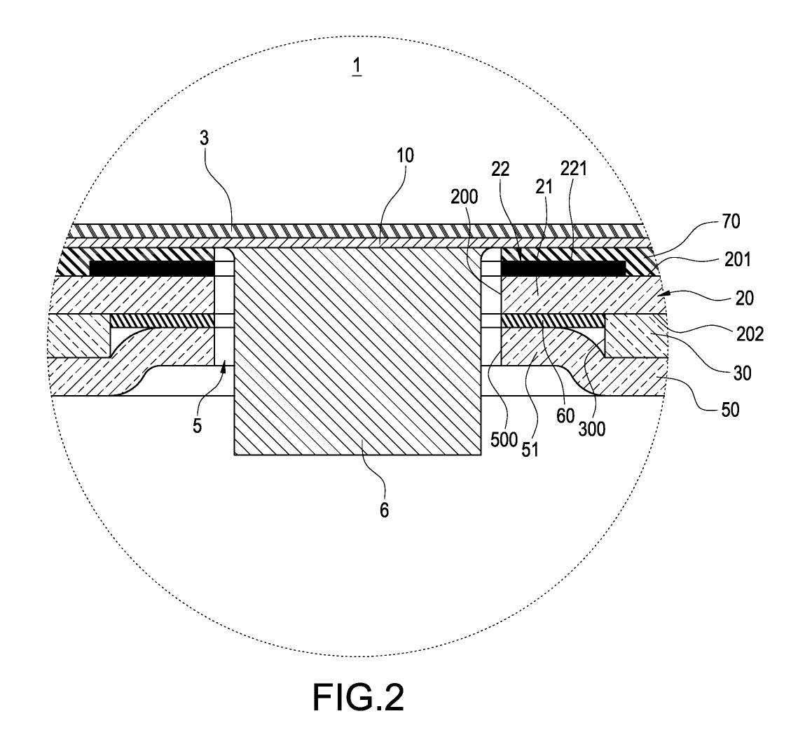

FIG. 1 and FIG. 2 are a sectional view and a partially enlarged view of a backlight module capable of avoiding light leakage, respectively. As shown in FIG. 1 and FIG. 2, the backlight module 1 capable of avoiding light leakage of the disclosure comprises a substrate 10, a shading film 20, a light guide plate 30, a light-emitting element 40, a reflective sheet 50 and a glue 60. The shading film 20, the light guide plate 30 and the reflective sheet 50 are disposed on one side of the substrate 10 in sequence. In this embodiment, the backlight module 1 further comprises an adhesive 70 disposed between the substrate 10 and the shading film 20.

Furthermore, the disclosure further provides a keyboard 2 having the backlight module capable of avoiding light leakage. The keyboard 2 comprises a circuit board 3, a plurality of keys 4 and the backlight module 1 of the disclosure. The keys 4 are connected to one side of the circuit board 3. The backlight module 1 (substrate 10) is disposed on another side of the circuit board 3. Moreover, the backlight module 1 comprises at least one hole 5 for a positioning stick 6 or other structures to be disposed on.

The substrate 10 may be made of metal, such as aluminum. The substrate 10 is used for the support plate of the keys 4 to be disposed on. The shading film is of plastic film, preferably. The shading film 20 has a first surface 201 and a second surface 202 opposite to each other. A first hole 200 is disposed on the shading film 20 and penetrates the first surface 201 and the second surface 202. The shading film 20 is connected to the substrate 10 via the first surface 201.

The light guide plate 30 is connected to the second surface 202 of the shading film. A second hole 300 corresponding to the first hole 200 is disposed on the light guide plate 30 and the aperture of the second hole 300 is greater than that of the first hole 200. One side of the shading film 20 near the first hole 200 has an extending section 21 while the other side near the second hole does not. A first shading portion 22 is disposed on the extending section 21 of the shading film 20.

The light-emitting element 40 is preferably to be a LED element. The light-emitting element 40 is disposed on a light entering side of the light guide plate 30. The light entering side may be one side of the light guide plate 30, or it may be a lateral wall of a through hole if the through hole is formed on the light guide plate 30 and the light-emitting element 40 is in the through hole. Light generated by the light-emitting element 40 transfers via the light guide plate 30.

The reflective sheet 50 is connected to one side of the light guide plate 30. A third hole 500 corresponding to the second hole 300 is disposed on the light guide plate 30 and the aperture of the third hole 500 is smaller than that of the second hole 300. A side of the reflective sheet 50 near the third hole 500 has an adhesive section 51 while the side of the light guide plate 30 near the second hole 300 does not.

The adhesive section 51 is connected to the extending section 21 and covers a side of the light guide plate 30 near the second hole 300, thereby preventing light of the backlight module 1 from emitting through the second hole 300. In this embodiment, a glue 60 is disposed between the extending section 21 and the adhesive section 51 so that the extending section 21 and the adhesive section 51 are stuck together by the glue 60. The glue 60 is preferably to be light-absorbing latex.

Specifically, the adhesive layer 70 is disposed between the substrate 10 and the first surface 201 of the shading film 20. The adhesive section 51 is connected to the second surface 202 of the shading film 20 via the adhesive layer 70. The adhesive section 51 is preferably to be a bent structure facing the shading film 20. In order to be bent, it may be made by thermoforming.

Additionally, the covering range of the first shading portion 22 extends from the edge of the first hole 200. The range of the shading portion 22 may cover the whole of the extending section or it may be slightly longer or shorter than the length of the extending section 21. In other words, the first shading portion 22 can be adjusted based on the circumstances (e.g. keys nearby). The shading portion 22 is preferably to be a black ink zone 221 made by printing. The arrangement of the shading portion 22 blocks light from leaking in the light guide plate 30 above the second hole 300.

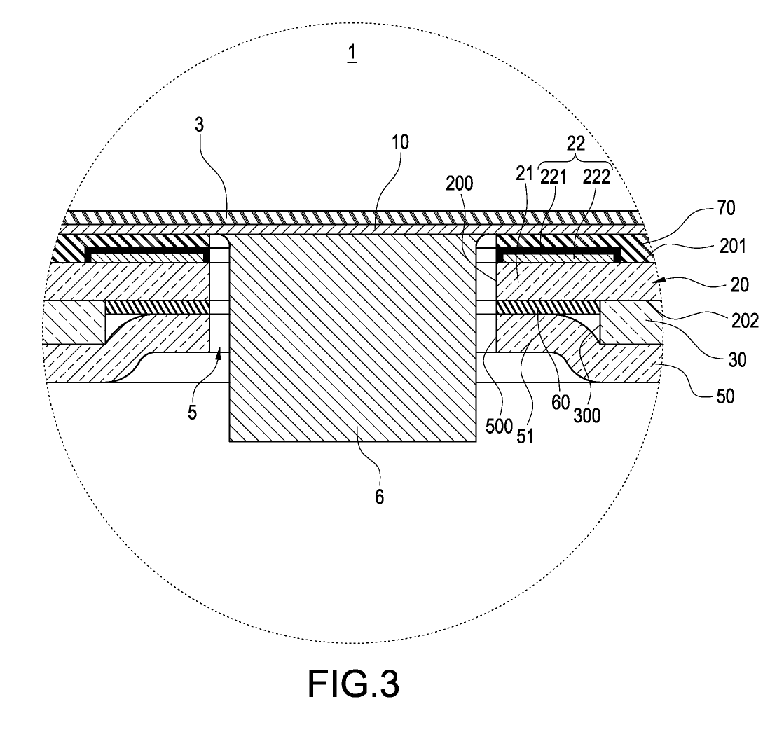

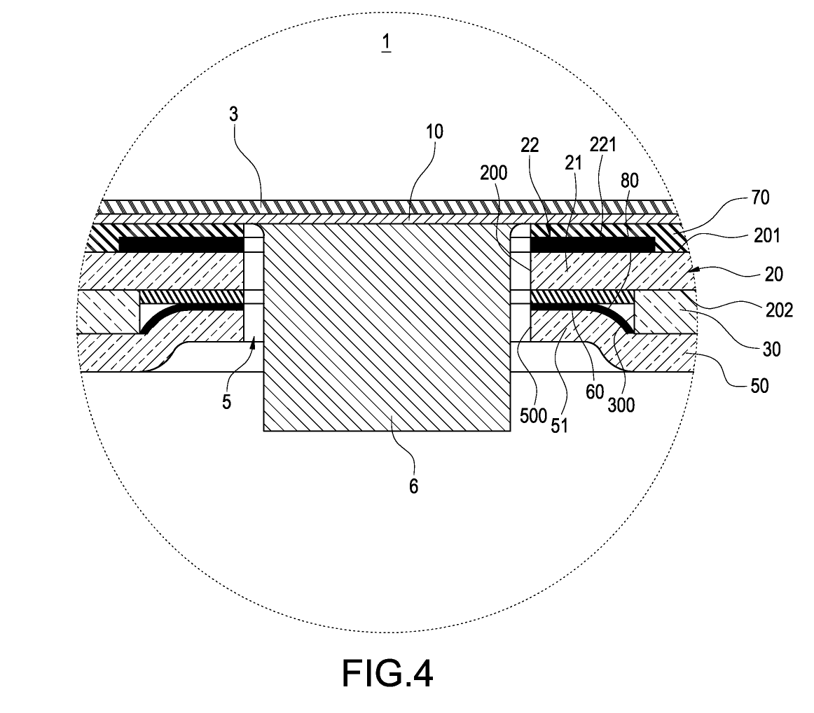

FIG. 3 and FIG. 4 show another two embodiments of the backlight module of the disclosure. As seen in FIG. 3, the first shading portion 22 further comprises a white ink zone, which is different from FIG. 2. The white ink zone 222 is below the back ink zone 222 and overlaps it. The area of the white ink zone 222 is smaller than or equal to the area of the back ink zone 221. Since the white ink zone 222 overlaps the black ink zone 221, the shading effect of the shading portion 22 is improved.

Compared with FIG. 2, the backlight module 1 of FIG. 4 further comprises a second shading portion 80 where the structure of the shading portion 80 is identical to that of the first shading portion 22. In this embodiment, the second shading portion 80 is disposed on one side of the adhesive section 51 facing the light guide plate 30. The arrangement of the second shading portion 80 is capable of avoiding light leakage at the position below the second hole 300 of the light guide plate 30 so the performance of light leakage is improved.

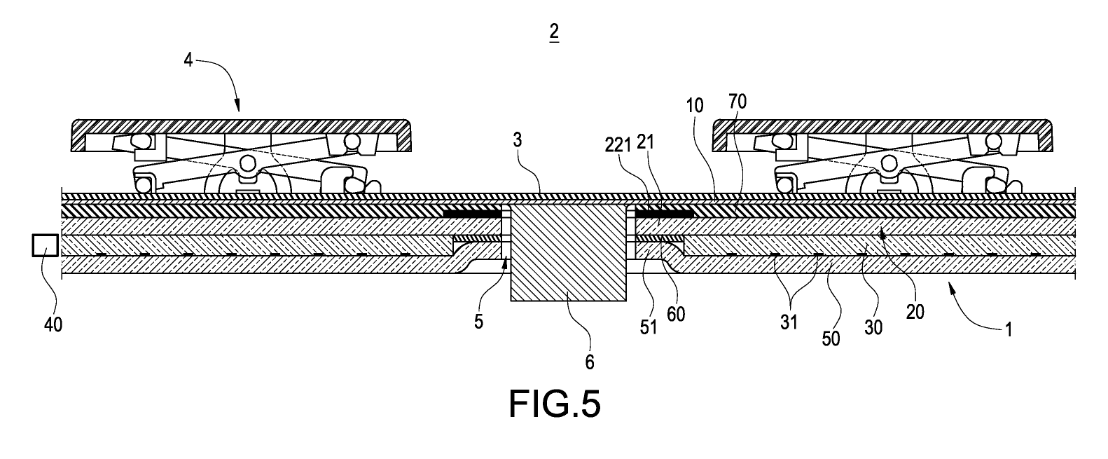

FIG. 5 is a schematic view of a backlight module capable of avoiding light leakage according to the other embodiment of the disclosure. Compared to FIG. 1, a plurality of reflective points 31 is disposed on the light guide plate 30. The use of the reflective points 31 can enhance the reflection efficiency of the light guide plate 30. By doing this, the backlight module 1 of the disclosure is not only capable of avoiding light leakage, but also has an improved performance of brightness.

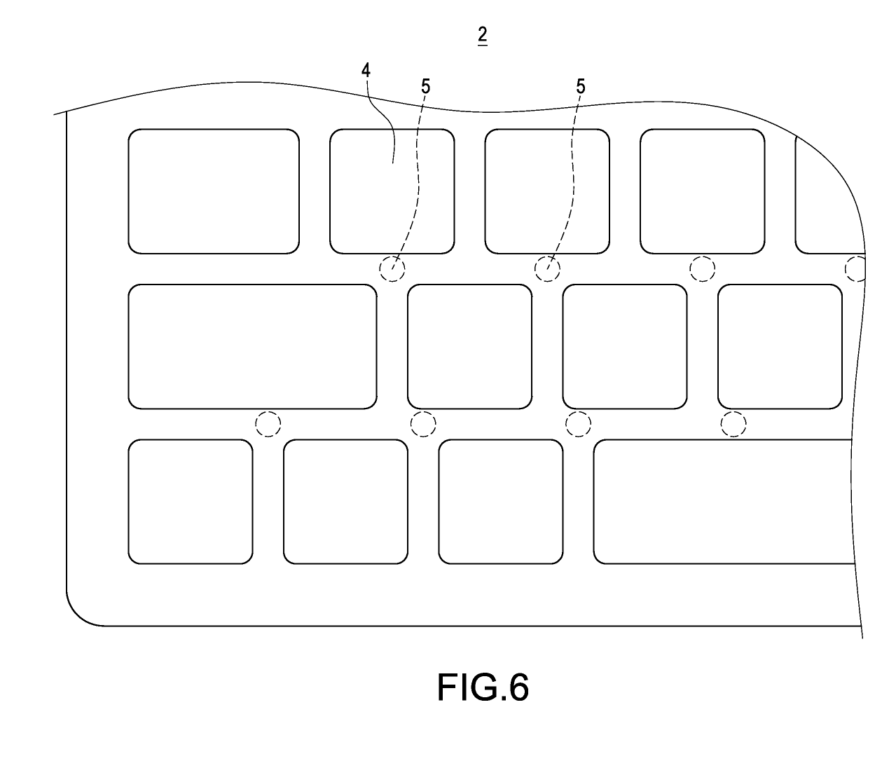

FIG. 6 is a schematic view of the positions of the holes of the disclosure. As seen in FIG. 6, the positions of the holes 5 correspond to the backlight module 1. That is, the position of the hole 5 is at the intersection of three keys 4 of the keyboard 2, approximately. However, the disclosure is not limited thereto.

What is claimed is:

1. A backlight module capable of avoiding light leakage, comprising:
a substrate;
a shading film having a first surface and a second surface opposite to each other, wherein the shading film forms a first hole penetrating the first surface and the second surface, and the shading film is connected with the substrate via the first surface;
a light guide plate connected to the second surface, wherein the light guide plate forms a second hole corresponding to the first hole while the aperture of the second hole is greater than that of the first hole, a side of the shading film near the first hole has an extending section while a side of the shading film near the second hole does not, and a first shading portion is disposed on the extending section of the shading film;
a light-emitting element disposed on a light entering side of the light guide plate; and
a reflective sheet connected to a side of the light guide plate, wherein the reflective sheet forms a third hole corresponding to the second hole while the aperture of the third hole is greater than that of the second hole, a side of the reflective sheet near the third hole has an adhesive section while a side of the light guide plate near the second hole does not, the adhesive section is connected with the extending section and covers a side of the light guide plate near the second hole, for preventing light generated from the light-emitting element from exiting through the second hole.

2. The backlight module capable of avoiding light leakage according to claim 1, wherein the extending section and the adhesive section are stuck together by a glue.

3. The backlight module capable of avoiding light leakage according to claim 1, further comprising an adhesive layer disposed between the substrate and the first surface of the shading film.

4. The backlight module capable of avoiding light leakage according to claim 1, wherein the first shading portion covers the whole of the extending section.

5. The backlight module capable of avoiding light leakage according to claim 1, wherein the first shading portion is a black ink zone made by printing.

6. The backlight module capable of avoiding light leakage according to claim 5, wherein the first shading portion further comprises a white ink zone below the black ink zone while the white ink zone and the black ink zone overlap, and the area of the white ink zone is smaller than or equal to the area of the black ink zone.

7. The backlight module capable of avoiding light leakage according to claim 1, further comprising a second shading portion disposed on a side of the adhesive section facing the light guide plate.

8. The backlight module capable of avoiding light leakage according to claim 1, wherein a plurality of reflective points are disposed on the light guide plate.

9. The backlight module capable of avoiding light leakage according to claim 2, wherein the glue is light-absorbing latex.

10. The backlight module capable of avoiding light leakage according to claim 1, wherein the adhesive section is bent and is made by thermoforming.

11. A keyboard capable of avoiding light leakage, comprising:
a circuit board;
a plurality of keys connected to one side of the circuit board; and
a backlight module comprising:
a substrate disposed on another side of the circuit board;
a shading film having a first surface and a second surface opposite to each other, wherein the shading film forms a first hole penetrating the first surface and the second surface, and the shading film is connected with the substrate via the first surface;
a light guide plate connected to the second surface, wherein the light guide plate forms a second hole corresponding to the first hole while the aperture of the second hole is greater than that of the first hole, a side of the shading film near the first hole has an extending section while a side of the shading film near the second hole does not, and a first shading portion is disposed on the extending section of the shading film;
a light-emitting element disposed on a light entering side of the light guide plate; and
a reflective sheet connected to a side of the light guide plate, wherein the reflective sheet forms a third hole corresponding to the second hole while the aperture of the third hole is greater than that of the second hole, a side of the reflective sheet near the third hole has an adhesive section while a side of the light guide plate near the second hole does not, the adhesive section is connected with the extending section and covers a side of the light guide plate near the second hole, for preventing light generated from the light-emitting element from exiting through the second hole.

12. The keyboard capable of avoiding light leakage according to claim 11, wherein the extending section and the adhesive section are stuck together by a glue.

13. The keyboard capable of avoiding light leakage according to claim 11, further comprising an adhesive layer disposed between the substrate and the first surface of the shading film.

14. The keyboard capable of avoiding light leakage according to claim 11, wherein the first shading portion covers the whole of the extending section.

15. The keyboard capable of avoiding light leakage according to claim 11, wherein the first shading portion is a black ink zone made by printing.

16. The keyboard capable of avoiding light leakage according to claim 15, wherein the first shading portion further comprises a white ink zone below the black ink zone while the white ink zone and the black ink zone overlap, and the area of the white ink zone is smaller than or equal to the area of the black ink zone.

17. The keyboard capable of avoiding light leakage according to claim 11, further comprising a second shading portion disposed on a side of the adhesive section facing the light guide plate.

18. The keyboard capable of avoiding light leakage according to claim 11, wherein a plurality of reflective points are disposed on the light guide plate.

19. The keyboard capable of avoiding light leakage according to claim 12, wherein the glue is light-absorbing latex.

20. The keyboard capable of avoiding light leakage according to claim 11, wherein the adhesive section is bent and is made by thermoforming.
